(19) United States
(12) Patent Application Publication
(10) Pub. No.: US 2012/0144737 A1
(43) Pub. Date: Jun. 14, 2012

(54) ABOVE GROUND COLLAPSIBLE GARDEN BED

(76) Inventor: Douglas E. Austin, Lorena, TX (US)

(21) Appl. No.: 12/964,937

(22) Filed: Dec. 10, 2010

(51) Int. Cl. A01G 9/02; B23P 11/00; A01G 1/00

(52) U.S. Cl. 47/33; 29/428

(57) ABSTRACT

A raised garden bed is provided. The raised garden bed is raised off the ground to minimize back strain when using and to provide ease of use for the mobility impaired. The raised garden bed is collapsible to provide ease of movement and to minimize storage space. A foldable, collapsible frame is provided. A water resistant garden bed liner is provided for holding soil and plant material. The garden bed liner is detachable from the frame. A drainage mechanism is provided to drain excess water from the garden bed.

### TECHNICAL FIELD

This invention relates generally to garden beds, and more particularly, a collapsible garden bed that is raised above ground level.

### BACKGROUND

Gardens that include a garden bed having a portion raised above ground level are known in the art of gardening. Raised garden beds provide a mechanism for growing plants without the need to stoop or get on ones knees in order to maintain the quality of the garden. Raised garden beds provide a garden bed that is particularly advantageous for use by the elderly or those with mobility problems. In addition, by raising the soil level, raised beds reduce back strain when bending over to tend the bed. In the past, gardens with raised garden beds often have included wooden boards and platforms. Numerous problems are associated with the use of wooden boards in raised garden beds. Wooden boards are susceptible to internal damage such as caused by wood rot and termites. In addition, often raised garden beds are heavy and difficult to move, even without soil and plant material. Further, such garden beds are bulky and need a large space for storage when not in use, such as for example, during non-growing seasons.

### SUMMARY

The problems of traditional raised garden beds and those identified above are in large part solved by the collapsible raised garden bed presented herein. This new raised garden bed allows consumers to grow a garden at heights that provide use of ease of the garden bed. In addition, a relatively lightweight garden bed is provided. Further, the garden bed may be collapsed such that minimal storage space is required when the garden bed is not in use.

The techniques described herein provide a solution to a collapsible raised garden bed. The garden bed is raised to a height above the ground by utilizing a collapsible detachable frame or stand. This is particularly helpful to those who are elderly or have mobility issues. Care of the garden can be accomplished without having to bend down. The entire garden can be stored away when not in use or moved to a different location. In one embodiment, the bed liner of the garden bed may be detachable from the frame so as to further minimize the needed storage space.

In one exemplary embodiment, a raised garden bed structure is provided. The raised garden bed structure may comprise a garden bed liner, the garden bed liner configured to hold garden bed materials. Further the structure may comprise a collapsible frame, the collapsible frame being configured to fold and unfold. The collapsible frame and the garden bed liner may also be configured to be coupled in a manner such when the collapsible frame is in an unfolded state the garden bed liner is supported by the collapsible frame such that a bottom of the garden bed liner is elevated above the ground.

In another exemplary embodiment, a raised garden bed structure is also provided. The structure may comprise a collapsible frame which may be folded and unfolded. The structure may also comprise a detachable garden bed liner, the garden bed liner being at least water resistant and configured to contain soil and/or plant material. The collapsible frame may support the garden bed liner such that a bottom of the detachable garden bed liner is supported above the ground when the detachable garden bed liner is coupled to the collapsible frame. The structure may also comprise a plurality of slots in the detachable garden bed liner for engaging at least part of the collapsible frame when the garden bed liner is supported by the frame. The slots may be configured such that the detachable garden bed liner may be slid off the collapsible frame when the detachable garden bed liner is detached from the collapsible frame.

In another exemplary embodiment, a method of assembling a raised garden bed structure is disclosed. The method may include providing a collapsible frame which may be folded and unfolded and providing a detachable garden bed liner having a bottom and sides configured to hold garden bed material. The coupling of the detachable garden bed liner to the collapsible frame may be performed in a manner that the detachable garden bed liner may detached and reattached, the coupling elevating a bottom of the detachable garden bed liner off the ground so as to assist in the ease of use of the raised garden bed structure.

In one aspect, the garden bed may be, though is not required to be, designed utilizing a water resistant material. The bed liner of the garden bed structure may be, though is not required to be, manufactured using a PVC coated canvas material. The supporting frame may be, though is not required to be, made of powder coated metal tubing and therefore will be rust resistant.

In another aspect, the raised garden bed allows for proper water drainage. A drain pipe is attached to the bottom of the garden bed allowing ability for the excess water from the soil to be drained.

### DESCRIPTION OF THE DRAWINGS

It is noted that the appended drawings illustrate only exemplary embodiments of the techniques described herein and are, therefore, not to be considered limiting of its scope, for the techniques may admit to other equally effective embodiments.

FIG. 1 is a depiction of the components of an above ground collapsible garden bed.

FIG. 2 is a depiction of the collapsible supporting frame or base.

FIG. 3 is a depiction of the collapsible frame or base in storage mode.

FIG. 4 is a depiction of the above ground collapsible garden bed fully assembled.

FIG. 5 is a bottom view of the fully assembled garden bed.

FIG. 6 is a depiction of a locking pin mechanism.

### DETAILED DESCRIPTION

With reference to the drawings, a new and improved raised garden bed apparatus embodying the principles and concepts will be described. Further modifications and alternative embodiments of the techniques described herein will be apparent to those skilled in the art in view of this description. It will be recognized, therefore, that the techniques described herein are not limited by these example arrangements. Accordingly, this description is to be construed as illustrative only and is for the purpose of teaching those skilled in the art the manner of carrying out the techniques described herein. It is to be understood that the forms of the techniques described herein shown and described are to be taken as the preferred embodiments.

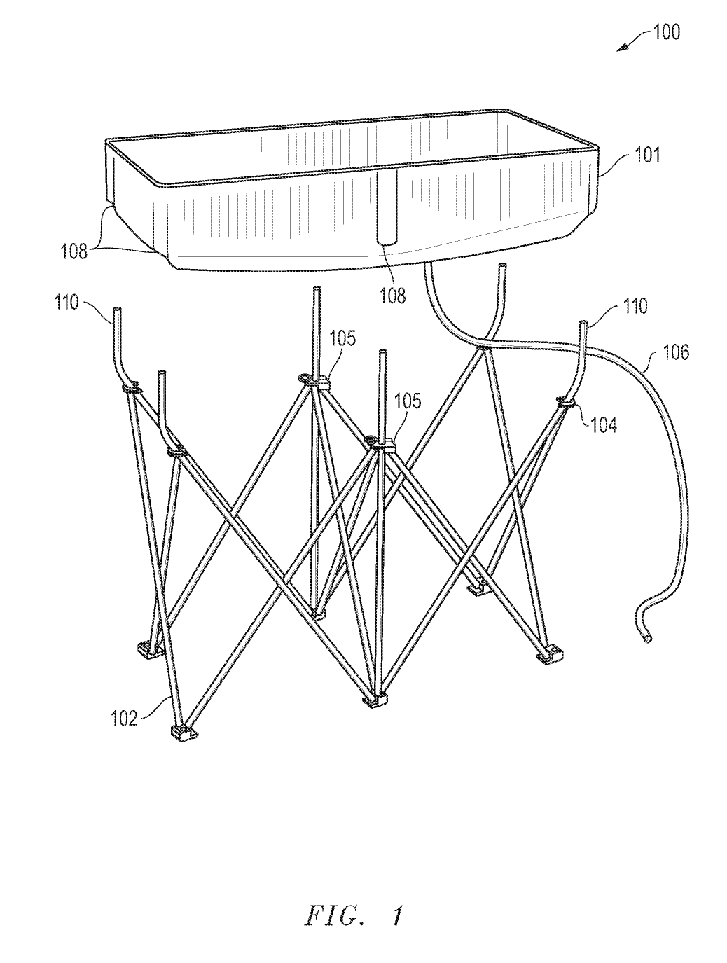

FIG. 1 depicts the components of an exemplary raised garden bed 100. The garden bed 100 may include a garden bed liner component 101 is a water resistant raised garden bed liner. This raised garden bed liner 101 is used to contain soil for the purpose of planting. In one embodiment, the garden bed is manufactured using a PVC coated canvas material, making the garden bed water resistant. The garden bed liner need not be water resistant and other materials, such as water proof materials may be used and even non-water resistant materials may alternatively be used. Thus, the concepts disclosed herein need not be limited to a particular garden bed liner material. The garden bed liner is also manufactured with slots 108. These slots 108 can be found on the four corners of the garden bed, as well as, two additional intermediary slots for added support. The slots 108 on the garden bed are configured to accept portions of the collapsible frame 102 as shown in FIG. 1 to so that the garden bed liner 101 may be supported by the collapsible frame 102. In this manner a raised garden bed is provided such that the bottom of the garden bed liner is elevated off the ground such as shown in FIG. 1.

The raised garden bed 100 may also have the ability to drain excess water. This may be accomplished by utilizing providing a drainage mechanism in the garden bed liner 101. In one example, a drain hose 106 is attached to the bottom of the garden bed liner 101 so that the water may drain form the soil contained in the liner. It will be recognized that other drainage mechanisms may also be utilized.

FIG. 1 also depicts the collapsible frame 102 that supports the garden bed in an unfolded position. The collapsible frame 102 may be made of a powder coated metal tubing material. Thus, the frame may a durable metal frame. It will be recognized that a wide range of materials may be used however to form a collapsible base that has sufficient strength to support the garden bed liner when filled with soil and plant material. Thus, the structural concepts of a collapsible raised garden bed as described herein are not limited to a particular material used to construct the frame. The collapsible metal frame engages the garden bed at six different locations as shown in FIG. 1 at the four corners and an additional two intermediary locations. The frame 102 engages the garden bed by the six support arms 110 where the support arms 110 meet with the slots 108 on the garden bed liner 101. This offers ample support for the garden bed. It will be recognized that the frame may be constructed with fewer or more support arms and the choice of such number of arms may be dependent upon the size of the garden bed. However, the use of four corner and two intermediary supports does provide an efficient support mechanism for a rectangular bed as show. The garden bed liner 101 may be detached from the collapsible frame merely by sliding the garden bed liner off the support arms which are engaged to the liner in the slots 108. In this manner the bed liner may be easily slid on and off the frame for attaching and detaching the bed liner from the frame.

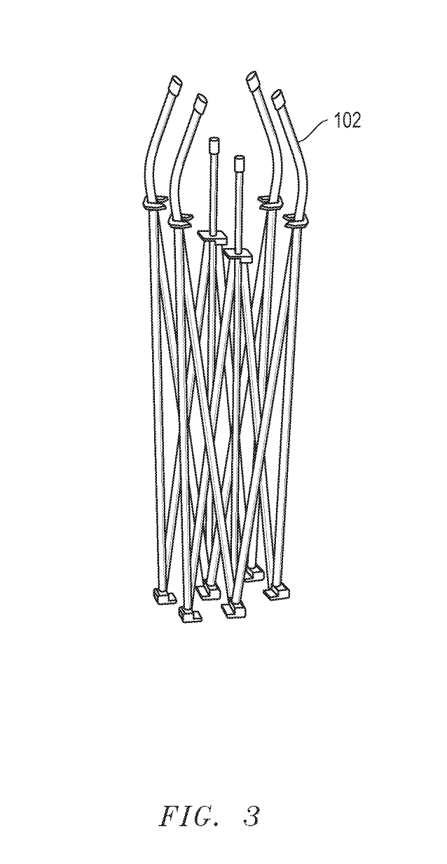

The collapsible frame 102, in FIG. 1, further employs metal clips 104 which are provided at various locations of the frame legs as shown in FIG. 1 to allow two leg cross members to be coupled together in a slidable manner. Further, multiple cross members may be engaged together with a frame leg with a sliding mechanism 105. The sliding mechanism 105 and the clips 104 allow for the connection of frame legs as shown in a manner that provides structural support for the raised garden bed 100 while allowing for the frame to be collapsible as described in more detail below and shown in FIG. 3.

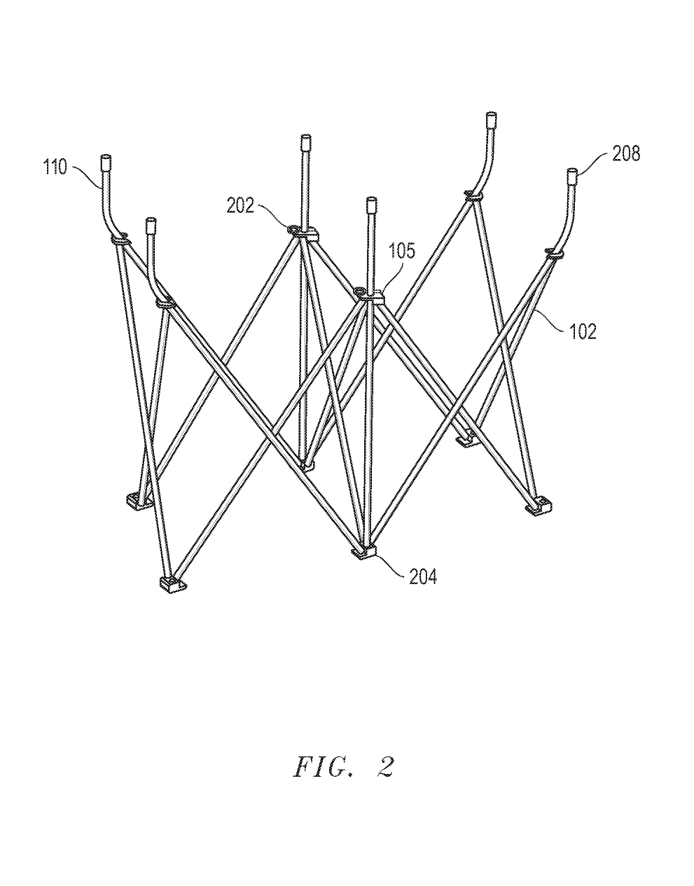

FIG. 2 is a depiction of the collapsible frame 102 for the raised garden bed in a fully unfolded configuration. As shown, each of the supporting arms may have an end cap 208 to prevent damage or tearing to the garden bed canvas material. Such end cap may be for example, but not limited to, a rubber or plastic end cap. The collapsible frame in FIG. 2 also depicts that the bottom of the frame has flat support feet 204. The support feet 204 provide stability to the raised garden bed, preventing tipping or wobbling. Locking pins 202 may also be provided to secure the frame 102 in its unfolded position. Locking pins 202 slide through holes provided in the frame 102 as shown in more detail below.

FIG. 3 is a depiction of the frame 102 in a collapsed configuration. The figure shows that the frame is detachable from the bed liner and collapsible for easy storage when the garden bed is not in use. The collapsible and detachable nature of the frame and garden bed makes for easy storage. In an alternative embodiment, the bed liner may be configured to permanently engage the frame and the whole unit may be folded together. Generally, in such an embodiment, the unit may not be as compact for storage.

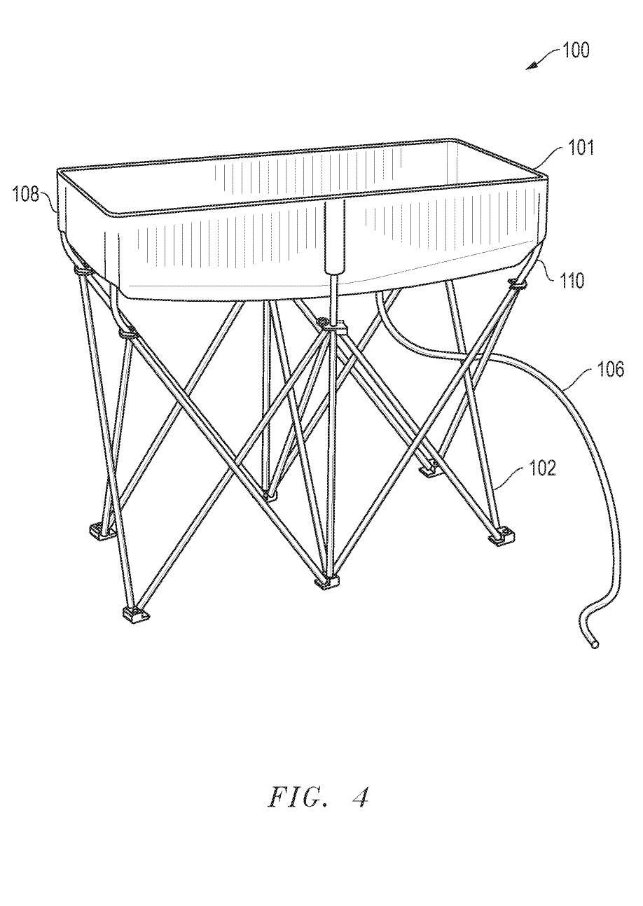

In FIG. 4, the fully assembled raised garden bed 100 is depicted. As shown, the raised garden bed liner 101 is engaged on the support arms 110 at the slots 108 of the bed liner 101. In one embodiment, the fully assembled raised garden bed is approximately 30 inches high.

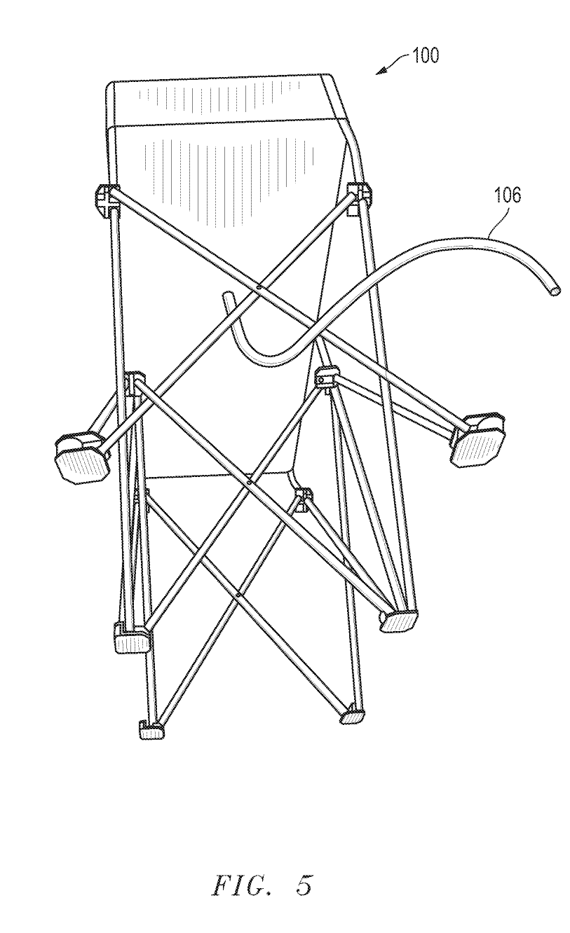

In FIG. 5, a fully assembled raised garden bed 100 is depicted with a view from the bottom. The bottom view of the assembled garden bed 100 shows the attached drain hose 106. The drain hose may be constructed of any of wide variety of materials such as plastics or rubber or the like. The drain hose 106 allows proper drainage of excess water from the garden bed. As shown, one center drainage location and a single drain hose are utilized. However, other drainage locations and more drainage locations may be utilized.

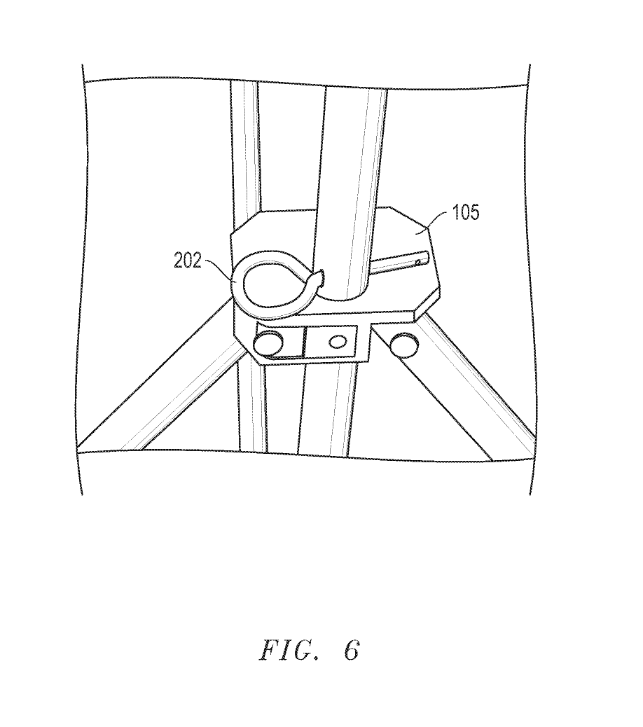

In FIG. 6, a locking pin mechanism is depicted. The metal locking pin 202 secures the collapsible frame or base in an unfolded position providing stability to the fully assembled raised garden bed. As shown in FIG. 6, the locking pin 202 extends through a leg of the frame 102 adjacent a sliding mechanism 105. When secured through the frame leg, the locking pin 202 prevents the frame from being moved into the collapsed position by providing a barrier that prevents the sliding mechanism 105 from moving upward past the pin location.

1. A raised garden bed structure, comprising:
a garden bed liner, the garden bed liner configured to hold garden bed materials; and
a collapsible frame, the collapsible frame being configured to fold and unfold, the collapsible frame and the garden bed liner configured to be coupled in a manner such when the collapsible frame is in an unfolded state the garden bed liner is supported by the collapsible frame such that a bottom of the garden bed liner is elevated above the ground.

2. The raised garden bed structure of claim 1, wherein the garden bed liner is detachable from the collapsible frame.

3. The raised garden bed structure of claim 2, wherein the garden bed liner has slots for accepting support arms of the collapsible frame, the garden bed liner resting on the collapsible frame at the slots when the garden bed liner is attached to the collapsible frame.

4. The raised garden bed structure of claim 3, wherein the garden bed liner may be detached from the frame by sliding the garden bed liner off the support arms.

5. The raised garden bed structure of claim 4, further comprising at least four support arms.

6. The raised garden bed structure of claim 4, further comprising four corner support arms and two intermediary support arms.

7. The raised garden bed structure of claim 1, wherein the garden bed liner is rectangular, the collapsible frame comprising four corner support arms and two intermediary support arms, the four corner support arms coupling to corners of the garden bed liner and the intermediary support arms coupling to mid-points of two sides of the garden bed liner.

8. The raised garden bed structure of claim 7, wherein the garden bed liner is detachable from the collapsible frame.

9. The raised garden bed structure of claim 8, further comprising slots in the garden bed liner, the garden bed liner resting on the collapsible frame at the slots when the garden bed liner is attached to the collapsible frame.

10. The raised garden bed structure of claim 1, further comprising a drain house coupled to the bottom of the garden bed liner.

11. A raised garden bed structure, comprising:
a collapsible frame which may be folded and unfolded;
a detachable garden bed liner, the garden bed liner being at least water resistant and configured to contain soil or plant material or a combination of soil and plant material, the collapsible frame supporting the garden bed liner such that a bottom of the detachable garden bed liner is supported above the ground when the detachable garden bed liner is coupled to the collapsible frame; and
a plurality of slots in the detachable garden bed liner for engaging at least part of the collapsible frame when the garden bed liner is supported by the frame, the slots configured such that the detachable garden bed liner may be slid off the collapsible frame when the detachable garden bed liner is detached from the collapsible frame.

12. The raised garden bed structure of claim 11, further comprising a plurality of support arms extending upward from the collapsible frame, the support arms sized to fit within the slots of the detachable garden bed liner.

13. The raised garden bed structure of claim 12, wherein the plurality of support arms comprise four corner support arms and two intermediary support arms, the four corner support arms coupling to corners of the garden bed liner and the intermediary support arms coupling to mid-points of two sides of the garden bed liner.

14. A method of assembling a raised garden bed structure, comprising:
providing a collapsible frame which may be folded and unfolded;
providing a detachable garden bed liner having a bottom and sides configured to hold garden bed materials; and
coupling the detachable garden bed liner to the collapsible frame, the coupling being in a manner that the detachable garden bed liner may detached and reattached, the coupling elevating a bottom of the detachable garden bed liner off the ground so as to assist in the ease of use of the raised garden bed structure.

15. The method of claim 14, further comprising placing soil and/or plant material in detachable garden bed liner.

16. The method of claim 14, the coupling of the detachable garden bed liner to the collapsible frame being accomplished with a plurality of slots in the detachable garden bed liner for engaging at least part of the collapsible frame when the detachable garden bed liner is supported by the frame, the slots configured such that the detachable garden bed liner may be slid off the collapsible frame when the detachable garden bed liner is detached from the collapsible frame.

17. The method of claim 16, further comprising locking the collapsible frame in an unfolded position.

18. The method of claim 17, further comprising utilizing a pin to lock the collapsible frame in the unfolded position.
